(19) United States
(12) Patent Application Publication
(10) Pub. No.: US 2011/0169408 A1
(43) Pub. Date: Jul. 14, 2011

(54) CIRCUIT STRUCTURE OF LIGHT-EMITTING DIODE (LED) LAMP

(76) Inventors: Hui San Chen, Taipei City (TW); Chih Tsai Wang, Tainan City (TW)

(21) Appl. No.: 12/786,914

(22) Filed: May 25, 2010

(30) Foreign Application Priority Data
Jan. 14, 2010 (DE) DE 202010000890.5

(51) Int. Cl. H01J 7/44

(52) U.S. Cl. 315/51

(57) ABSTRACT

A circuit structure of light-emitting diode (LED) lamp includes a combination of at least one LED lamp assembly, a current-limit resistor, a bridge rectifier, a capacitor set, a circuit board, and an electrical connector, by which each LED of at least one LED lamp assembly is at one end in series with a serially-connected resistor individually and then each serial-connected by-pass resistor is in parallel with the former-mentioned electrical structure to form a LED lamp assembly. The present invention provides a better solution which conventional LED lamp cannot be configured with a high voltage power supply. Further, the hardware lay-out of the circuit structure allows for direct connection with an external power source of AC 100-380V, which is fed through the bridge rectifier for regulation and conversion into direct current to be directly coupled to and used by the LED lamp assembly without a voltage-down transformer.

### BACKGROUND OF THE INVENTION

1. Field of the Invention

The present invention is related to a circuit structure of light-emitting diode (LED) lamp, and more particularly to a structure of a combination of at least one LED lamp assembly, a current limit resistor, a bridge rectifier, a capacitor assembly, a circuit board, and an electrical connector, which allows electrical current to flow through a by-pass resistor for continuously powering of the remaining LED lamps when one of LEDs within the serially-connected LED lamps is interrupted by a burned-out resistor so as to provide a better solution of being convenient to use, lighting performance, and significantly reducing total power consumed by the serially-connected LED lamps and is thus applicable to various circuit structure of LED lamps or the likes.

2. Description of Prior Art

Recently, light-emitting diode (LED) lamps are prevailing due to the concept of energy saving and are thus considered a practice for lighting in the era of energy shortage. An LED lamp comprises a low-voltage actuated chip type light-emitting diode. So far, with serial connection of multiple LEDs are adopted as a prior art, power supply through the multiple serially-connected LEDs is cut off whenever there is a burned-out LED which necessarily leads to mal-function of the LEDs. Besides, the power supply cannot be realized through a serial connection of high voltage, so that only a limit number of LEDs can be connected in series first and then a parallel connection is made among those strings of above-mentioned serially-connected LEDs. When there is a burned LED, the whole string in series with that LED can't provide light function, but the LEDs of the other strings are not affected. Currently, LED lamps are powered with low voltage in a combined serial and parallel connection to form a lighting device and a low-voltage transformer is required.

FIG. 1 shows a conventional LED lamp, which comprises a power supply circuit including an alternate-current (AC) plug 1, a low-voltage transformer 2, a socket set 3, an extension cable 4, serial-connection resistors 5, and LEDs 6. The whole assembly of LED lamp formed in this arrangement is of high cost, making it not conveniently to be widely used at ordinary homes.

Further, the arrangement of the power supply for the conventional LED lamp uses low voltage to activate the LEDs. To expand the illuminated area by the light of the LEDs, an arrangement of parallel connection of multiple strings of serial connection of a limited number of LEDs might be the only way to meet that necessity. Thus, the conventional LED lighting devices currently available in the market all adopt the arrangement of parallel connection of multiple strings of serial-connected LEDs. In such an arrangement, when one LED burns out, that string of the LEDs is completely powered off which results to reduced overall brightness and in turns leads to deteriorated lighting performance. This is a major problem of the conventional LED lamps and apparently it makes the conventional LED lamps not so practical in use for general consumers.

### SUMMARY OF THE INVENTION

Accordingly, the primary objective of the present invention is to provide a circuit structure of LED lamp, which comprises a combination of at least one LED lamp assembly, a current-limit resistor, a bridge rectifier, a capacitor set, a circuit board, and an electrical connector, whereby either one or more burned-out LEDs does not cause power-off of the other LEDs to conduct the power continuously through by-pass resistors so as to avoid terminating the lighting function of the other LEDs and thus to provide advantages of convenient use and significantly enhance the overall function.

The secondary objective of the present invention is to provide a circuit structure of LED lamp, which comprises a combination of at least one LED lamp assembly, a current-limit resistor, a bridge rectifier, a capacitor set, a circuit board, and an electrical connector, so as to allow direct use of household or industrial power of alternate current (AC) 100-380V, wherein the AC power, which is first rectified by the bridge rectifier and further subjected to the voltage regulated by the capacitor set, is supplied to the at least one LED lamp assembly to energize each of a number of LEDs that are connected in series without being first fed through a low-voltage transformer, and only at a minor expense of current consumed through the by-pass resistors, whereby the lighting performance of the at least one LED lamp assembly is improved and the overall operation of lighting is significantly enhanced.

In order to achieve the above-mentioned objectives, the present invention provides a circuit structure of LED lamp, which comprises a combination of at least one LED lamp assembly, a current-limit resistor, a bridge rectifier, a capacitor set, a circuit board, and an electrical connector, wherein the LED lamp assembly comprises a plurality of LEDs that are connected in series to effectively reduce the total power consumption. A serially-connected resistor is set to correspond to and in serial connection with an end of each LED. A plurality of by-pass resistors are connected in series and each of the by-pass resistors is set in parallel with both two ends of a combination of each LED and the serially-connected resistor. The serially-connected resistors are provided to set up the limit voltage and/or current for the LED lamp assembly. When a LED lamp burns out, continuous conduction of power for the LED lamp assembly is made through the related by-pass resistor so as to continuously energize the remaining, normally-functioned LEDs. In this way, the problem that the conventional LED lamp cannot be arranged in a serial connection with high voltage power supply can be solved. Furthermore, the circuit structure of the present invention allows for direct connection with an external power source of AC 100-380V, which is fed through the bridge rectifier to conversed and regulated into a direct current directly coupled to and used by the LED lamp assembly without a low voltage transformer and thereby enhance the overall function and practicability.

### BRIEF DESCRIPTION OF THE DRAWINGS

The present invention can be fully understood from the following detailed description and preferred embodiment with reference to the listed drawings, in which:

FIG. 1 is a schematic view illustrating a circuit arrangement for an existing low-voltage LED lamp;

FIG. 2A illustrates a circuit arrangement according to the present invention;

FIG. 2B illustrates the arrangement of resistors on a circuit board according to the present invention;

FIG. 3A illustrates the arrangement of electrical components on the circuit board of light tube compatible type according to the present invention;

FIG. 3B illustrates the arrangement of LEDs on the circuit board of light tube compatible type according to the present invention;

FIG. 4A is a partly perspective view illustrating the inside details of a light tube compatible type according to the present invention;

FIG. 4B is a plan view illustrating the light tube compatible type according to the present invention;

FIG. 5A is a plan view illustrating a FL27W type compatible LED lamp according to the present invention;

FIG. 5B is a plan view illustrating a PLS13W type compatible LED lamp according to the present invention;

FIG. 5C is a plan view illustrating a compatible angle-adjustable screw type LED lamp according to the present invention;

FIG. 6A is a perspective view illustrating a compatible light-mending angle-adjustable LED lamp;

FIG. 6B is a perspective view illustrating a compatible light projection circular LED lamp; and

FIG. 6C is a perspective view illustrating a compatible angle-adjustable screw type LED lamp.

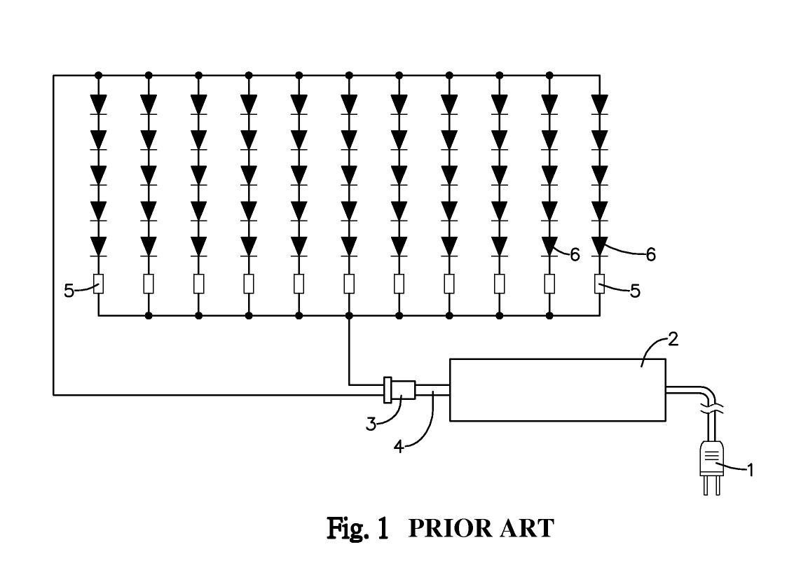

### DETAILED DESCRIPTION OF THE PREFERRED EMBODIMENTS

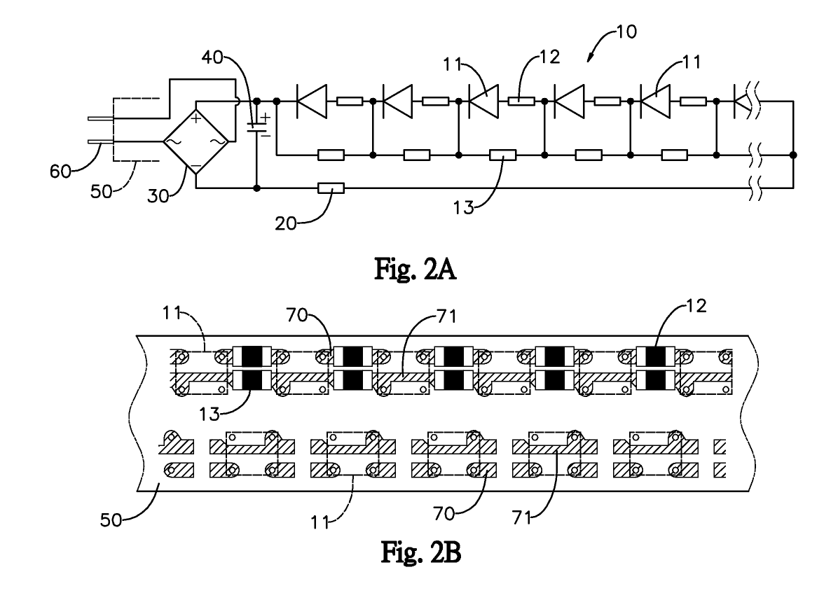

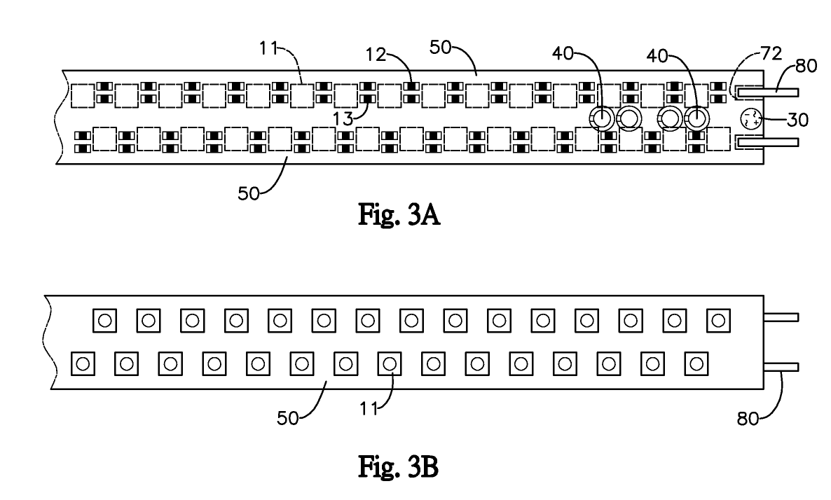

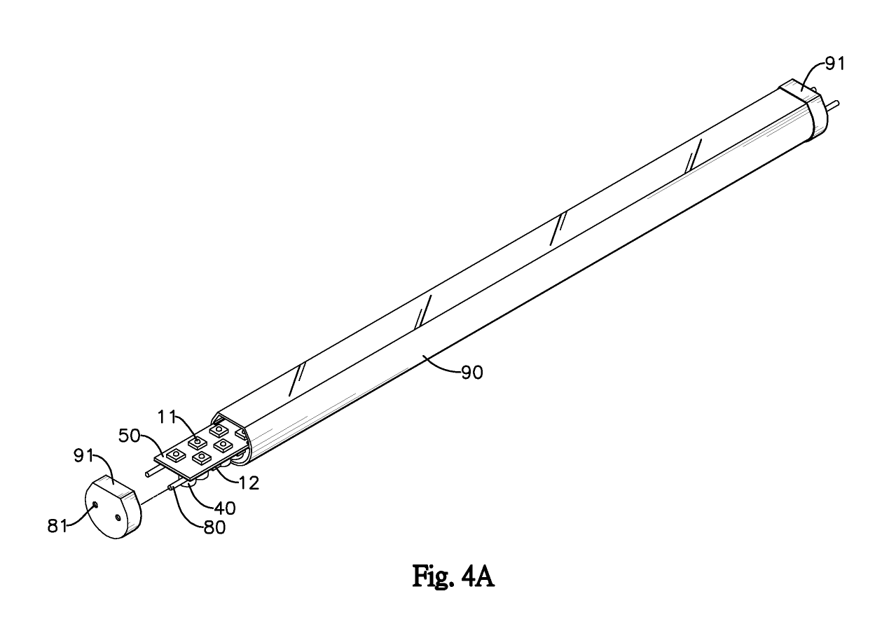

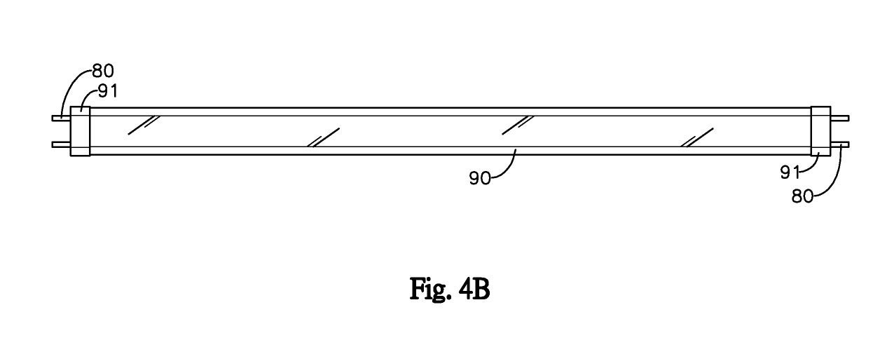

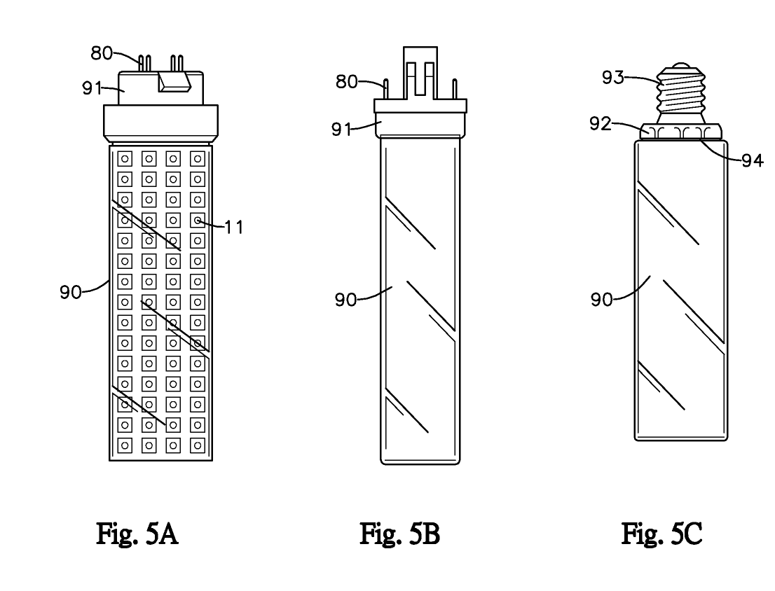

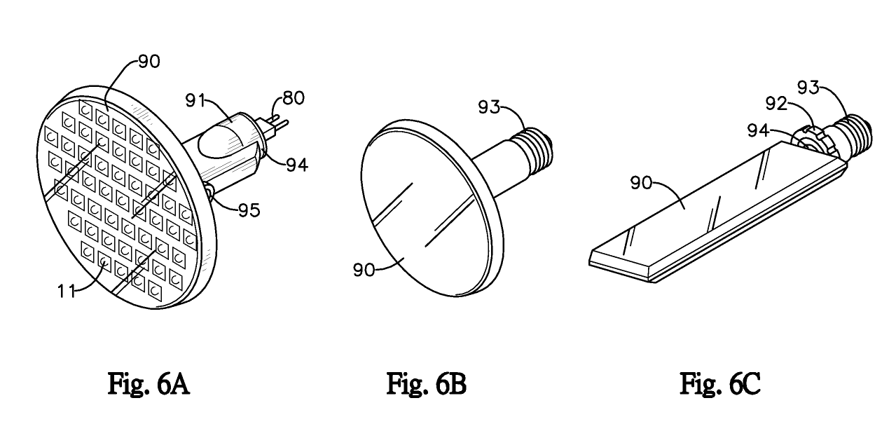

With reference to the drawings from FIGS. 2A to 6C, the present invention provides a circuit structure of light-emitting diode (LED) lamp which comprises constituent components described below.

At least one LED lamp assembly 10 consists of a plurality of LEDs 11, a plurality of serially-connected resistors 12, and a plurality of by-pass resistors 13. The plurality of LEDs 11 is connected in series with each other. Each of the serially-connected resistors 12 is set to correspond to and in serial connection with an end of each of the LEDs 11. A plurality of by-pass resistors 13 are connected in series with each other and each of the by-pass resistors 13 is connected, in parallel, to two ends of a combination of each LED 11 and the serially-connected resistor 12 connected thereto. The at least one LED lamp assembly 10 can be a single assembly 10 of LED lamps or includes a plurality of LED lamp assemblies 10 that are connected in parallel with each other.

A current-limit resistor 20 has an end connected in series with an end of the at least one LED lamp assembly 10.

A bridge rectifier 30 functions to receive an input of an alternate current (AC) power supply. The bridge rectifier 30 is set in electrical connection with an alternative end of the at least one LED lamp assembly 10 and an alternative end of the current-limit resistor 20.

A capacitor set 40 one end electrically connected between the bridge rectifier 30 and the at least one LED lamp assembly 10 and the other end connected with the current-limit resistor 20.

A circuit board 50 has the at least one LED lamp assembly 10, the current-limit resistor 20, the bridge rectifier 30, and the capacitor set 40 to mount thereon.

An electrical connector 60, which can be a plug type, a rotary type, or a pin type connector, is connected to an end of the circuit board 50. The electrical connector 60 and the bridge rectifier 30 are in electrical connection with each other to accept the input of the AC power supply.

With the above-described components, a circuit structure of LED lamp is formed. As shown in FIGS. 2A-6C, the circuit structure according to the present invention comprises a combination of at least one LED lamp assembly 10, a current-limit resistor 20, a bridge rectifier 30, a capacitor set 40, a circuit board 50, and an electrical connector 60, wherein the at least one LED lamp assembly 10 comprises a plurality of LED lamps 11 that is in serial connection with each other so as to effectively reduce the total power consumption of the plurality of LEDs and each of the serially-connected resistors 12 is set to correspond to and in serial connection with an end of each of the LEDs 11. The plurality of by-pass resistors 13 is connected in series and each of the by-pass resistors 13 is set in parallel connection with two ends of a combination of each LED 11 and the serially-connected resistor 12 connected thereto. Experimental tests show that an input of AC 110V that is fed through the bridge rectifier can be boosted to approximately DC 155V, which with the additional conduction realized through the by-pass resistors 13, allows for providing serial connection of tens of LED lamps 11. The additional path realized by the by-pass resistors 13 makes it possible to eliminate the need for a transformer to serve as a matching component. Further, for the application in LEDs 11, when one or more of the LEDs 11 are burned out, the remaining LEDs 11 in front thereof or located therebehind are not affected to unexpected power off. The additional conduction realized through the by-pass resistors 13 makes it possible not to affect the lighting of the remaining LEDs 11, therefore providing an advantage of convenience of use and thus significantly enhancing the overall function and practicability. Further, with the combination of at least one LED lamp assembly 10, a current-limit resistor 20, a bridge rectifier 30, a capacitor set 40, a circuit board 50, and an electrical connector 60 provided by the circuit structure of the present invention, direct use of household or industrial power of AC 100-380V is available, wherein the AC power, which is first rectified by the bridge rectifier 30 and further subjected to voltage regulated by the capacitor set 40, is supplied to the at least one LED lamp assembly 10 to energize each of the LEDs 11 that are connected in series without being first fed through a low-voltage transformer, and only at a minor expense of current consumed through the by-pass resistors 13, whereby the lighting performance of the at least one LED lamp assembly 10 is improved. Thus, the present invention offers the advantages of convenient use and increased lighting performance, and thus the overall function and practicability are significantly enhanced.

FIGS. 2A to 6C illustrate various compatible types of LED lamp according to the present invention. All these types of lamp illustrated incorporate the circuit structure according to the present invention for replacing the existing fluorescent lamps, PL type lamps, and BB type lamps which comprising components as copper pads 70 for LED serial connection, copper pads 71 for LED parallel connection, copper pads 72 for pins connection, pins 80 of compatible light tube, holes 81 for the pins, LED light tube 90, cap 91 of LED light tube, turning knob 92, screw top 93, rotation shaft 94, and angle adjusting shaft 95), whereby the circuit structure of LED lamp according to the present invention can achieve the goals of energy saving and reducing costs of components/parts of LED lamp, and also realize environmental conservation.

What is claimed is:

1. A circuit structure of light-emitting diode (LED) lamp, comprising:
at least one LED lamp assembly, which comprises a plurality of LEDs, a plurality of serially-connected electrical resistors, and a plurality of by-pass resistors, wherein the plurality of LEDs are connected in series with each other, each of the serially-connected resistors is set to correspond to and in serial connection with an end of each of the LED, the plurality of by-pass resistors are connected in series with each other, each of the by-pass resistors is respectively connected, in parallel, to two ends of a combination of each of the LED and the serially-connected resistor connected thereto;
a current-limit resistor, which has an end connected in series with an end of the at least one LED lamp assembly;
a bridge rectifier, which is arranged to accept the input of an alternate current power supply, is set in electrical connection with an alternative end of the at least one LED lamp assembly and an alternative end of the current-limit resistor;
a capacitor set, which is one end electrically connected between the bridge rectifier and the at least one LED lamp assembly and the other end connected with the current-limit resistor;
a circuit board, which receives the at least one LED lamp assembly, the current-limit resistor, the bridge rectifier, and the capacitor set to mount thereon; and
an electrical connector, which is connected to an end of the circuit board, and the other end is in electrical connection with the bridge rectifier to receive the input of the AC power supply.

2. The circuit structure of LED lamp according to claim 1, wherein the at least one LED lamp assembly comprises a plurality of LED lamp assemblies connected in parallel with each other.

3. The circuit structure of LED lamp according to claim 1, wherein the electrical connector comprises a plug type connector.

4. The circuit structure of LED lamp according to claim 1, wherein the electrical connector comprises a rotary connector.

5. The circuit structure of LED lamp according to claim 1, wherein the electrical connector comprises a pin type connector.
